(19) United States
(12) Patent Application Publication
(10) Pub. No.: US 2005/0151818 A1
(43) Pub. Date: Jul. 14, 2005

(54) Printing system using ink-jet printer

(75) Inventor: Chizuo Ozawa, Shiojiri-shi (JP)

Correspondence Address: BURNS DOANE SWECKER & MATHIS L L P, POST OFFICE BOX 1404, ALEXANDRIA, VA, 22313-1404, US

(73) Assignee: Mastermind Co., Ltd., Nagano (JP)

(21) Appl. No.: 10/503,663

(22) PCT Filed: Sep. 3, 2002
(86) PCT No.: PCT/JP02/08960

(51) Int. Cl. B41J 2/01

(52) U.S. Cl. 347/104

(57) ABSTRACT

In an artificial nail printing system (201), each artificial nail printing shop (204) has numerous containers (212) containing artificial nail support bases (243) to which artificial nail materials (211) are adhered. When a customer chooses a desired container (212) and artificial nail printing data, the artificial nail support base (243) is removed from the container and positioned as is, on a carrier surface (74) of the media transport tray (7) of an inkjet printer (1). By transporting the media transport tray (7), each artificial nail material (211) adhered to the artificial nail support base (243) carried thereon is printed. After the printing, the printed surface of the artificial nail material (211) is dried and a protective topcoat is applied.

### TECHNICAL FIELD

The present invention relates to a printing system utilizing an inkjet printer that transports a media transport tray loaded with printing media via an inkjet head printing position to print on the surface of the printing media.

### TECHNICAL FIELD

In general, inkjet printers use water-based ink, so the printing media used are usually limited to materials having good water-based ink fixability. Also, the shape of the printing media used is limited to thin sheets that can pass the position at which the printing is effected by the inkjet head.

In JP-A 2001-30615, in order to print on surfaces of various printing media, the present applicant proposed a method of using an inkjet printer to print on various printing media having a water-absorbing or water-repelling surface, and in JP-A 10-368327proposed an inkjet printer in which the printing media transport tray is conveyed past the inkjet head printing position and the gap between the printing media transport tray and the inkjet head can be adjusted.

An object of this invention is to provide a printing system using an inkjet printer that can readily and efficiently print desired data on various types of printing media.

### DISCLOSURE OF THE INVENTION

The printing system of this invention is characterized by comprising

a container that houses printing media,

an inkjet printer for printing on the printing media,

a drive controller that controls the driving of the inkjet printer,

the container including a media support sheet on which the printing media is removably loaded, and a container main body in which the media support sheet is removably housed, and

the inkjet printer including an inkjet head, a media transport tray that can be moved through a position at which printing is carried out by the inkjet head, and a gap adjustment mechanism that adjusts a gap between the inkjet head and the media transport tray, the media transport tray being capable of carrying the media support sheet in a positioned state, wherein

the media transport tray carrying the media support sheet is conveyed through the printing position to carryout prescribed printing on a surface of the printing media carried on the media support sheet.

The drive controller has a printing data supply section that supplies the inkjet printer with printing data. This printing data supply section can be comprised of a printing data acquisition section that acquires printing data externally, and a printing data storage section that stores the acquired printing data.

The printing data acquisition section can be constituted by at least one selected from among a printing data receiving section that receives printing data via a communications network such as the Internet, a printing data reading section that reads in printing data stored on storage media such as CD or DVD, and an image reading section that acquires printing data from a scanner that directly reads in image data from printed materials or from a digital camera or video disc or the like.

The printing data supply section of the drive controller has a printing data selection section that selects printing data to be supplied to the inkjet printer. The printing data selection section can be comprised of a keyboard and/or a touch-panel as a printing data selection signal input section.

Next, this invention relates to a delivery data printing system, characterized by having a printing data delivery center that delivers printing data, and a plurality of printeries equipped with the printing system having the above configuration able to receive printing data that is delivered.

The printing media in the printing system of the invention can be artificial nails. In this case, adhesive can be used to detachably affix a plurality of sheets of artificial nail material having no design or the like printed thereon to the surface of the media support sheet.

A water-based ink image receiving layer can be formed on the printing surface of the artificial nail materials and the inkjet printer used to print on the image receiving layer in water-based ink.

Also, it is desirable that the printing system has a drier to dry the printed image formed on the image receiving surface of the artificial nail material.

### BRIEF DESCRIPTION OF THE DRAWINGS

FIG. 1 is a block diagram showing the present invention applied to an artificial nail printing system.

FIG. 2 is an explanatory drawing showing the container housing the artificial nail materials used in the printing system of FIG. 1, a cross-section of the artificial nail material support base, and a perspective view of a collection holder.

FIG. 3 is an explanatory drawing showing the process of applying an undercoating to the artificial nail material.

FIG. 4 is an explanatory drawing showing the printing procedure at an artificial nail printing shop in the printing system of Figure FIG. 5 is a plan view of an inkjet printer that can be used in the printing system of FIG. 1.

FIG. 6 is a side view along line II-II of the inkjet printer of FIG. 5.

FIG. 7 is a cross-sectional view along line III-III of the inkjet printer of FIG. 5.

FIG. 8 is a perspective view of the media transport tray of the inkjet printer of FIG. 5.

FIG. 9 is a perspective view of the gap adjustment mechanism of the inkjet printer of FIG. 5.

FIG. 10 is an explanatory drawing showing the side configuration of the gap adjustment mechanism of the inkjet printer of FIG. 5.

FIG. 11 is an explanatory drawing showing another example of the gap adjustment mechanism of an inkjet printer that can apply the present invention.

### BEST MODE FOR CARRYING OUT THE INVENTION

An example of the artificial nail printing system according to the present invention will now be described.

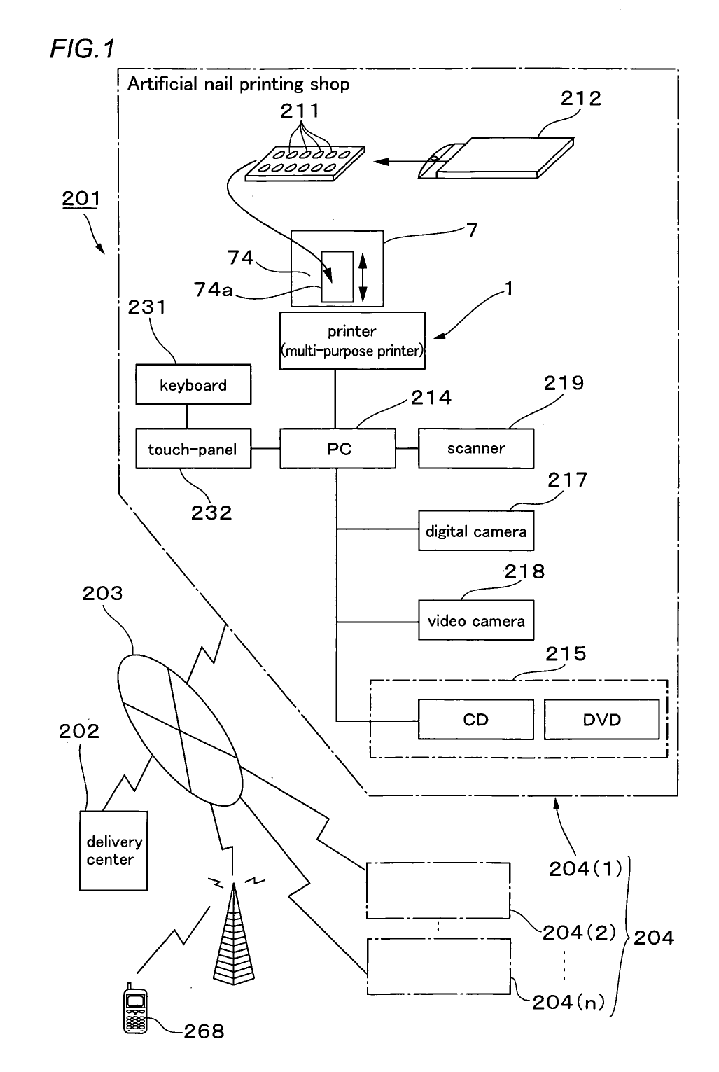

FIG. 1 is a block drawing showing the general configuration of the artificial nail printing system of this example. The printing system 201 includes a delivery center 202 that delivers artificial nail printing data, and a plurality of artificial nail printing shops 204 (204 (1), 204 (2) . . . 204 (n)) that can be connected with the delivery center 202 via a communications network 203 such as the Internet.

Each of the artificial nail printing shops 204 has a container 212 that contains artificial nail material 211 (with no design, picture and the like printed on the surface), an inkjet printer 1 for printing on the surface of the artificial nail material 211, and a personal computer 214 constituting a drive controller that controls the inkjet printer 1.

The personal computer 214 has a CPU, ROM, RAM, and a bus used to send and receive data and control signals, and a printing data supply function for supplying printing data to the inkjet printer 1. By means of this printing data supply function, printing data is acquired from peripheral devices connected to the personal computer 214 and the acquired printing data is stored in RAM or the like.

In this example, the personal computer 214 is equipped with an Internet communication function and can receive printing data via the Internet 203. It also includes a CD or DVD drive 215 and can read artificial nail printing data recorded on CD, DVD or the like. Image data for artificial nail applications can be read in from a digital camera 217 or a video camera 218 or the like; images on printed materials and film images can be directly read in as the artificial nail printing data by means of a scanner 219.

In addition, stored artificial nail printing data can be selected via an input section in the form of a keyboard 231. A touch-panel 232 is connected for selecting artificial nail printing data; the printing data can be readily selected by means of the touch-panel 232.

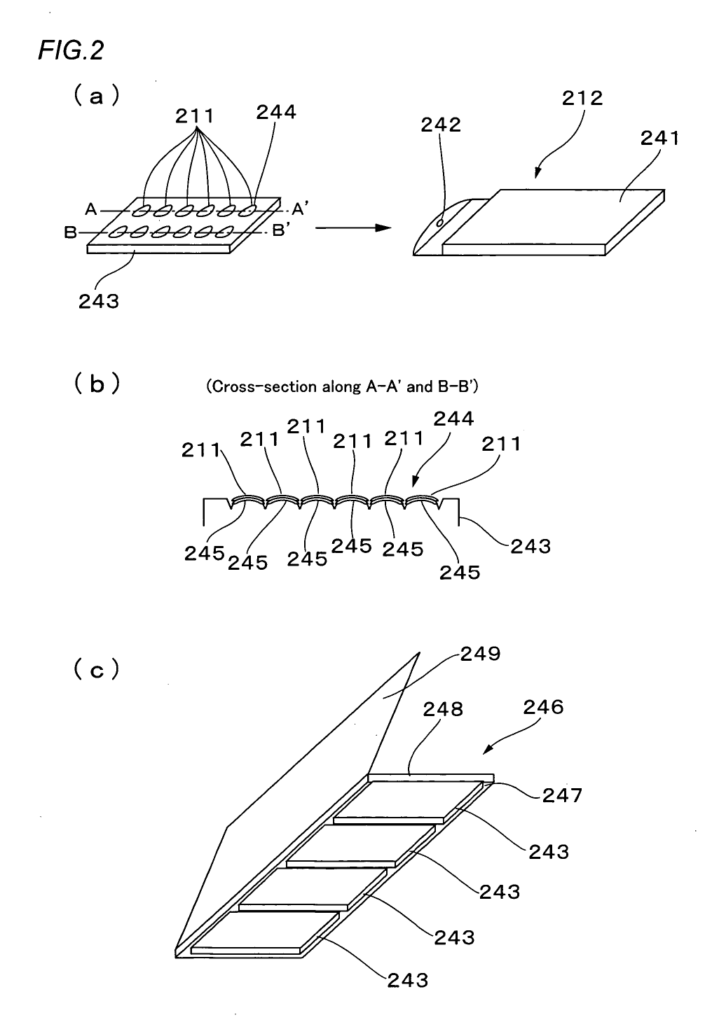

Next, FIG. 2 shows the configuration of the container 212 containing the artificial nail materials 211. A container main body 241 of the container 212 is, for example, in the shape of a flat, square body made of cardboard with a lid at the end that can be opened and closed, and which has a hole 242 formed therein for hanging from a hook for display in a shop. The container main body 241 contains a rectangular artificial nail material support base 243. Formed on the upper surface of the artificial nail material support base 243 are attachment surfaces 244 for the artificial nail materials 211, having a curved cross-section and spaced at fixed intervals. Each attachment surface 244 has an adhesive layer 245 that enables the artificial nail material 211 to be detachably attached thereto.

In this example, as well as the containers 212, each of the artificial nail printing shops 204 has collection holders 246. The collection holder 246 has a mount 247, a container section 248 for housing the artificial nail material support bases 243 formed on the surface thereof, and a lid 249 that covers the artificial nail support bases 243 housed in the container section 248. The collection holder 246 can hold a plurality of artificial nail support bases 243 to which artificial nails have been affixed after the nails have been printed with a design or the like; in the illustrated example, a collection holder 246 can hold four artificial nail support bases 243.

Next, as shown in FIG. 1, the inkjet printer 1 has a media transport tray 7 that is conveyed through an inkjet head printing position. Formed on the upper surface of the media transport tray 7 is a carrier surface 74 for carrying the artificial nail support base 243. To position the artificial nail support base 243, a shallow recess 74a is formed in the carrier surface 74 into which the artificial nail support base 243 fits into place. The detailed configuration of the inkjet printer 1 is described later.

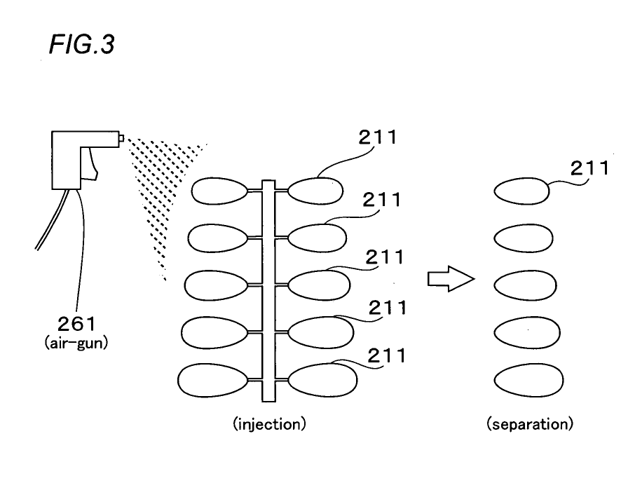

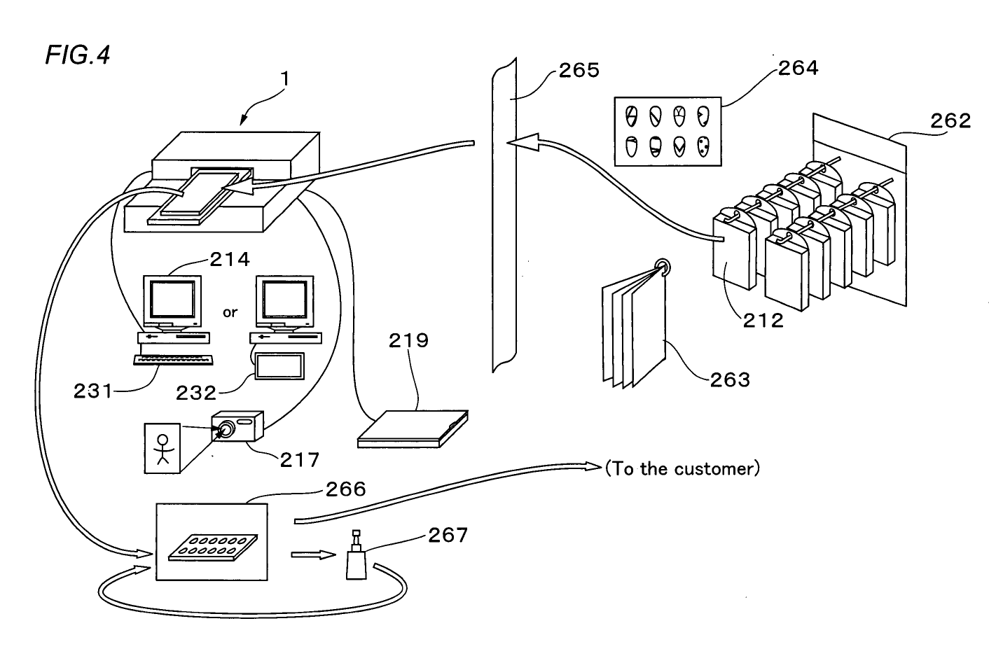

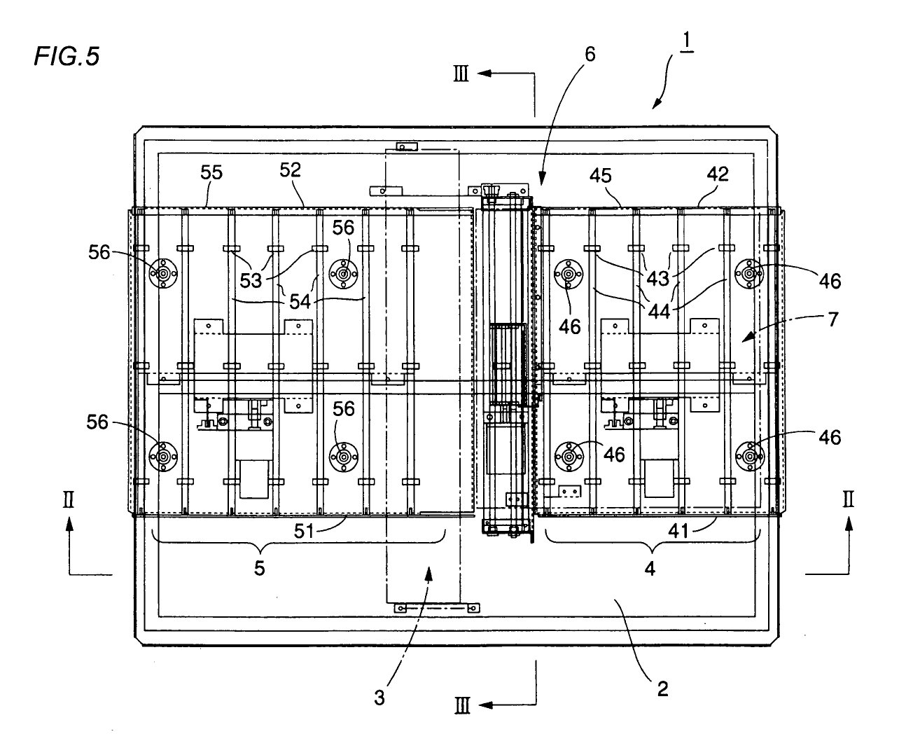

Next, printing operations in the artificial nail printing shops 204 will be described, with reference to FIGS. 3 and 4. First, the artificial nail material 211 is conventionally manufactured of molded resin. When the artificial nail material 211 is removed from a molding machine, it is given an undercoating to form a water-based ink image receiving layer on the surface thereof. For example, as shown in FIG. 3, an air-gun 261 is used to apply the undercoating to the artificial nail material 211 that has been removed from the molding machine. After the undercoating has dried, each piece of the artificial nail material 211 is removed and adhered to each attachment surface of the artificial nail material support base 243. The undercoating can be applied after the artificial nail material 211 is removed.

Next, as shown in FIG. 4, an artificial nail stand 262 is installed in a shop front of each of the artificial nail printing shops 204 on which are displayed containers 212 containing many types of artificial nail material. There is also an artificial nail design book 263 showing the various designs and the like that can be printed on the artificial nails. There is also a signboard 264 for showing new artificial nail designs.

The artificial nail printing data corresponding to the designs shown in the artificial nail design book 263 is stored in RAM or external memory (not shown) of the personal computer 214 of the printing system 201. There is also a place for storing new designs. The artificial nail printing data can be selected via the keyboard 231 or by a touch of the touch-panel 232. That is, touch-panel touch-keys carry numbers and symbols corresponding to storage locations of the artificial nail printing data. These numbers and symbols are also assigned to the artificial nail designs in the artificial nail design book 263.

A customer who comes to the artificial nail printing shop 204 selects the desired artificial nail material from the artificial nail stand 262; that is, she selects the container 212 containing artificial nail material of the desired shape and material. The customer also selects the desired printing data from the artificial nail design book 263. After making her selection, she goes to the shop counter 265, hands the selected container 212 to a shop assistant and tells the shop assistant the number of the selected printing data. After the shop assistant receives payment, the artificial nail material is printed.

Printing of the artificial nail material is carried out as follows. The artificial nail support base 243 with the adhered artificial nail material 211 is removed from the container 212 and placed in the positioning recess 74a formed in the carrier surface 74 of the media transport tray 7. Then, using the touch-panel 232 or keyboard 231, the printing data the customer wants is specified and the inkjet printer 1 is operated. The transporting of the media transport tray 7 carrying the artificial nail support base 243 starts, and as the artificial nail material 211 adhered to the artificial nail support base 243 carried on the media transport tray 7 passes through the printing position, the selected printing data is printed in water-based ink on the surface (the surface on which the image receiving layer is formed) of each artificial nail material 211.

After the printing is completed, the artificial nail support base 243 is removed from the media transport tray 7 and placed in a provided drier 266 to dry the printed surface. Next, a commercial topcoat 267 is applied to provide a clear protective layer that protects the printed surface of the artificial nail material. After the topcoat has been applied, it is again placed in the drier 266 to dry the topcoat. As a result, artificial nails printed with the desired design are obtained which are handed to the customer.

Via the Internet 203, artificial nail printing data can be received from the delivery center 202 on a regular basis or when required. Via the Internet 203, the printing data from the delivery center 202 can also be delivered to a portable information terminal, such as a mobile telephone 268, for example, and downloaded from the portable information terminal to the personal computer 214 of the artificial nail printing shops 204 (see FIG. 1). Moreover, data on hand, such as photographic data, for example, read by the scanner 219 can be used as printing data, or printing data stored on CD, DVD or FD or the like can be read in. In addition, image data from the digital camera 217 or video camera 218 can also be acquired as printing data.

The foregoing explanation has been made with reference to the use of artificial nail material as the printing media. However, the present invention can be used for printing of other media. For example, it can be applied in the same way to balls, tiles, bricks, stones, timepieces, rings and other personal accessories, and office products.

(Inkjet Printer Example)

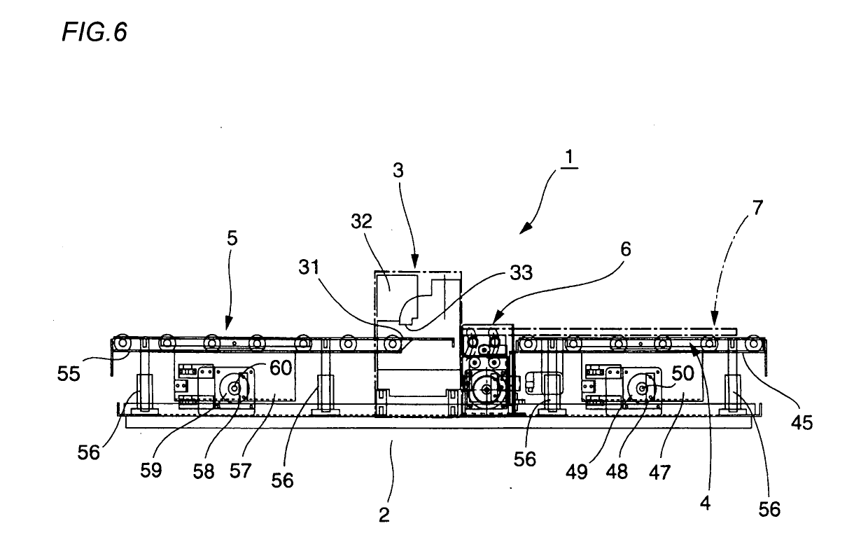

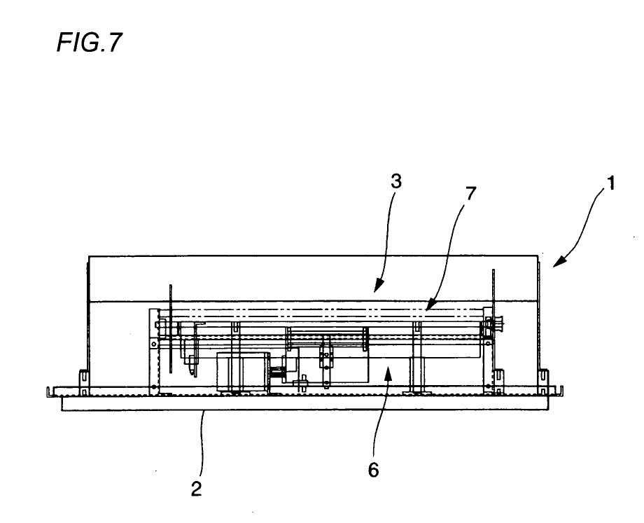

Next, example configurations of an inkjet printer 1 that can be used in this printing system 201 will be described, with reference to FIGS. 5 to 11. FIG. 5 is a plan view of the inkjet printer of this example, FIG. 6 is a side view along line II-II of FIG. 5, and FIG. 7 is a cross-sectional view along line III-III of FIG. 5.

Explained with respect to these drawings, the inkjet printer 1 of this example has a frame 2, an inkjet head unit 3 positioned substantially in the center of the upper surface thereof, a paper-feed-side flatbed (tray guide) 4 located on the paper-feed side of the head unit 3, a paper-delivery-side flatbed (tray guide) 5 located on the paper-delivery side of the head unit 3, and a tray transport unit 6 located between the head unit 3 and the delivery-side flatbed 5. By means of the tray transport unit 6, the media transport tray 7 is moved reciprocally along a transport path through a printing position 31 by the head unit 3.

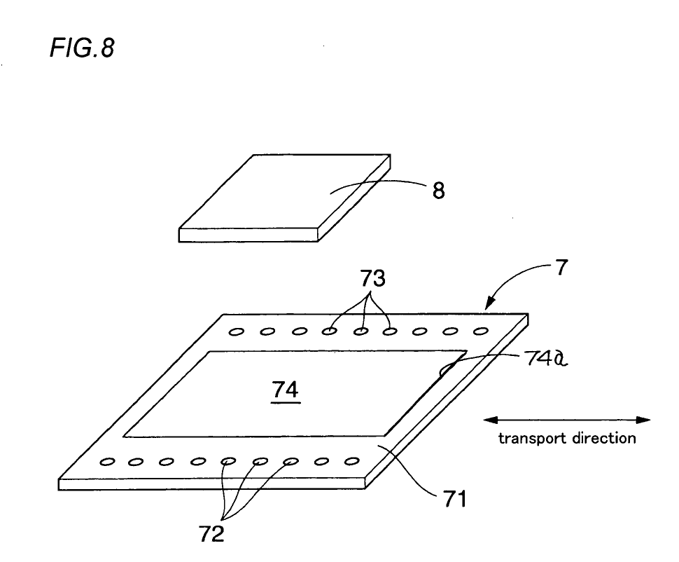

FIG. 8 is a perspective view of the media transport tray. As shown, the media transport tray 7 includes a square plate 71 of a set thickness, and a row of sprocket holes 72 and 73 formed along each edge thereof, in the transport direction. The region on the flat surface of the square plate 71 enclosed by a dotted line is the recording media carrier surface 74. Recording media 8, such as a thick wooden tablet, is placed on this carrier surface 74.

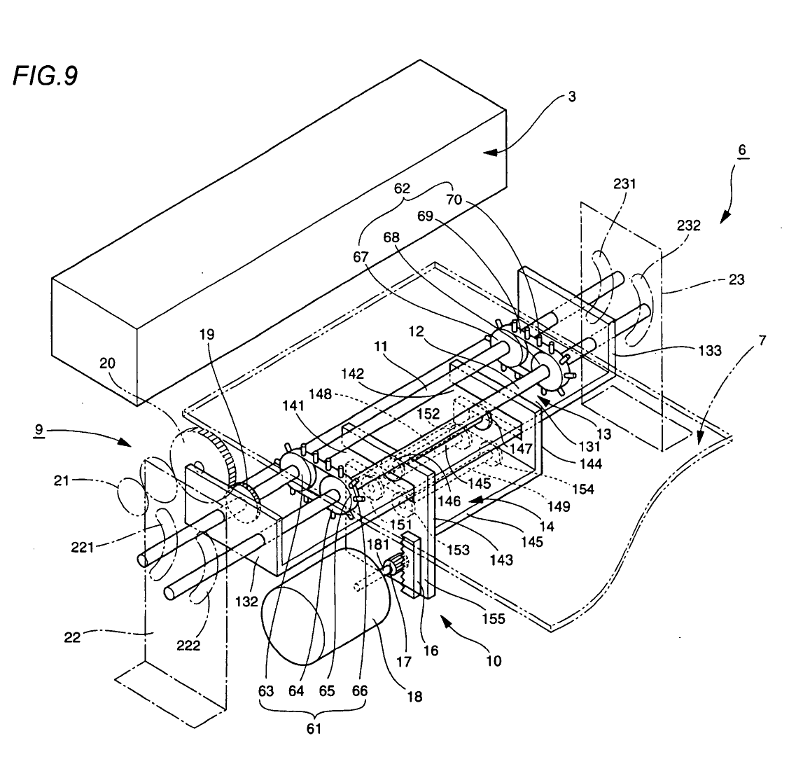

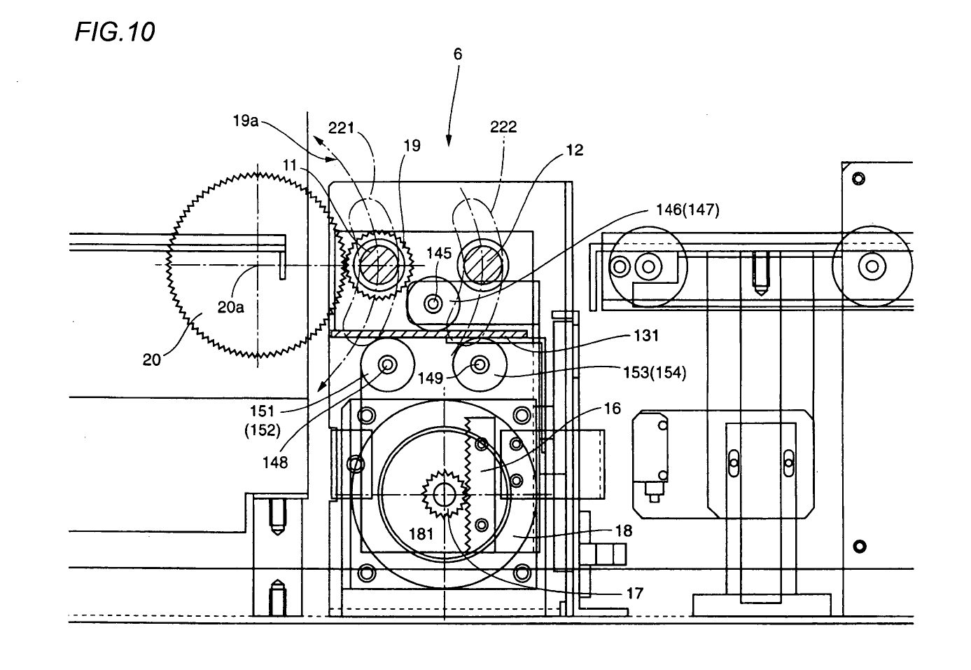

FIGS. 9 and 10 are perspective and side views of the tray transport unit 6. Explained with respect to these drawings, the tray transport unit 6 has a pair of sprockets 61 and 62 that can engage with the sprocket holes 72 and 73 along the edges of the media transport tray 7, a gap adjustment mechanism 10 that can move the sprockets 61 and 62 towards and away from a nozzle surface 33 (see FIG. 6) of an inkjet head 32 of the head unit 3, and a drive transmission mechanism 9 that rotatably drives the pair of sprockets 61 and 62.

The sprocket 61 comprises two gearwheels 63 and 64, a toothed belt 65 around the two gearwheels 63 and 64, and engaging projections 66 formed at regular intervals around the outer surface of the toothed belt 65. The toothed belt 65 forms a loop that is elongated in the direction in which the media transport tray is moved. The other sprocket 62 has a similar construction, comprising two gearwheels 67 and 68, a toothed belt 69, and engaging projections 70 formed at regular intervals around the outer surface of the toothed belt 69. The height of a media tray transport plane is defined by the upper horizontal outer surfaces of the toothed belts 65 and 69.

(Gap Adjustment Mechanism)

The gap adjustment mechanism 10 includes a rotational shaft 11 on which the gearwheels 63 and 67 of the sprockets 61 and 62 are concentrically affixed, and a rotational shaft 12 on which the other gearwheels 64 and 68 of the sprockets 61 and 62 are concentrically affixed. These shafts 11 and 12 are rotatably maintained by a support plate 13. The support plate 13 includes a bottom portion 131 and side portions 132 and 133 that extend vertically up from both ends of the bottom portion 131. The shafts 11 and 12 are mounted horizontally and in parallel spanning the side portions 132 and 133, perpendicular to the travel direction.

The center of the bottom portion 131 of the support plate 13 is supported by a lift member 14. The lift member 14 has sideplate portions 143 and 144 in which are formed horizontal openings 141 and 142 that can receive the bottom portion 131 from a horizontal direction, and a horizontal bottom portion 145 that connects the lower ends of the sideplate portions 143 and 144.

Between the sideplate portions 143 and 144, a rotational shaft 145 extends horizontally across at the upper sides of the horizontal openings 141 and 142. Rotatably fixed to each end of the rotational shaft 145 are rotatable upper presser rollers 146 and 147. Between the sideplate portions 143 and 144, two rotational shafts 148 and 149 extend horizontally across at the lower sides of the horizontal openings 141 and 142. Rotatably fixed to each end of the rotational shafts 148 and 149 are rotatable lower presser rollers 151 and 152, and 153 and 154.

When horizontally inserted into the horizontal openings 141 and 142 formed in the sideplate portions 143 and 144, the support plate bottom portion 131 is sandwiched vertically between the upper presser rollers 146 and 147 and the lower presser rollers 151 and 152, and 153 and 154. Therefore, the support plate 13 can slide horizontally while being moved vertically.

The lift member 14 has an extension portion 155 that extends down from the sideplate portion 143 and is affixed to a vertical rack 16. A pinion 17 that engages with the rack 16 is fixed to the output shaft 181 of a stepping motor 18 used for raising and lowering.

Thus, when the stepping motor 18 is driven, the rotational force of the motor is converted into vertical motion for raising and lowering the lift member 14. When the lift member 14 moves up or down, the support member 13 is also moved up or down, as well as the sprockets 61 and 62 affixed to the shafts 11 and 12 suspended by the support member 13. Thus, the gap between the plane of transport of the media transport tray defined by the sprockets 61 and 62 and the inkjet head 32 of the head unit 3 is increased or decreased accordingly.

(Drive Transmission Mechanism)

Next, the driving force transmission mechanism for driving the sprockets 61 and 62 will be explained. A follower gearwheel 19 is concentrically affixed to one end of the rotational shaft 11 on which the sprockets 61 and 62 are disposed. The follower gearwheel 19 is in engagement with a drive gearwheel 20 affixed to the frame 2. The drive gearwheel 20 is linked to the transport motor (not shown) via a speed-reduction gear train 21. Thus, when the drive motor is operated, the rotational shaft 11 is rotated via the drive gearwheel 20 and follower gearwheel 19, whereby the sprockets 61 and 62 also rotate as one unit, thereby moving the media transport tray 7 riding on the sprockets 61 and 62.

The shafts 11 and 12 pass through the sideplate portions 132 and 133 and extend horizontally to the outside thereof. Located on the outside of the sideplate portions 132 and 133 are a guide plate 22 with curved slide openings 221 and 222, and a guide plate 23 with curved slide openings 231 and 232. The ends of the shafts 11 and 12 are slidably disposed through the curved slide openings 221 and 222, and 231 and 232.

A scan be readily understood from FIG. 10, the follower gearwheel 19 moving up or down is in engagement with the drive gearwheel 20 that is fixed in position. Because the follower gearwheel is always in engagement with the drive gearwheel 20, the follower gearwheel 19 has to go up or down along a curved locus 19a having the rotation center 20a of the drive gearwheel 20 as its center. In this example, the shafts 11 and 12 are made to move slidably in the curved slide openings 221 and 222, and 231 and 232 along a curved locus 19a.

To slide the shafts 11 and 12 up and down in the curved slide openings, the shafts must also be moved horizontally along with their sliding motion. In this example, as described above, the support plate 13 on which the shafts 11 and 12 are maintained is horizontally slidably supported by the lift member 14 which has upper presser rollers 146 and 147 and lower presser rollers 151 and 152, and 153 and 154. Consequently, raising and lowering is possible with the follower gearwheel 19 maintaining engagement with the drive gearwheel 20.

(Flatbed Structure)

In the inkjet printer 1 of this example, the up and down movement of the flatbeds 4 and 5 is linked to the up and down movement of the sprockets 61 and 62. Thus, the transport plane defined by the sprockets 61 and 62 is always located on the same flat plane as the transport plane of the media transport tray 7 formed by the flatbeds 4 and 5.

Explained with reference to FIGS. 5 to 7, the flatbeds 4 and 5 have tray guides 41 and 42, and 51 and 52 used to guide the media transport tray 7. They also have a plurality of rollers 43 and 53 that prescribe the transport plane of the media transport tray 7. The shafts 44 and 55 on which these rollers 43 and 53 are rotatably supported are supported on horizontal support frames 45 and 55, which by means of vertical linear guides 46 and 56, are supported in a way that allows them to move vertically. Attached to the horizontal support frames 45 and 55 are brackets 47 and 57 that extend downwards and to which racks 48 and 58 are perpendicularly attached. Pinions 50 and 60 affixed to the output shafts of bed lift motors 49 and 59 are engaged with the racks 48 and 58.

When the motors 49 and 59 are operated, the horizontal support frames 45 and 55 can be moved up or down. In this example, by linking the operation of the motors 49 and 59 to the motor 18 used to raise or lower the tray transport unit 6, the tray transport plane defined by the sprockets 61 and 62 is always maintained at the same height as the tray transport plane defined by the flatbeds 4 and 5.

As explained in the foregoing, in the inkjet printer 1 of this example, by having the media transport tray 7 move reciprocally through the printing position, it is possible to print each artificial nail material 211 attached to the artificial nail support base 243 constituting the recording media 8 carried by the media transport tray 7. The media transport tray 7 is moved by the sprockets 61 and 62, which enables heavy recording media to be transported more securely, compared to the usual friction-based transport mechanisms that use paper-feed rollers.

Also, by moving the sprockets 61 and 62 vertically according to the thickness of the artificial nail support base 243 loaded in the media transport tray 7, the gap between the artificial nail material 211 and the nozzle surface 33 of the inkjet head 32 can be kept constant. This makes it possible to also print on thick material.

Moreover, this example includes flatbeds 4 and 5 located at each end in the transport direction that are raised and lowered as one unit with the sprockets 61 and 62. Thus, a long media transport tray 7 can also be transported by also using the flatbeds 4 and 5 to support the media transport tray 7.

(Other Embodiments)

The above example related to a printer equipped with sprockets that engage to move the media transport tray. The invention can, however, use friction rollers as transport members. In such a case, too, the gap between the media transport tray and the print head, as defined by the rollers, can be adjusted by using the lift mechanism to support the rollers.

In the above example, dedicated motors are used to raise or lower the flatbeds 4 and 5. However, by linking the horizontal support frames 45 and 55 of the flatbeds 4 and 5 to the lift member 14 that is raised or lowered by the lift motor 18 of the tray transport unit 6, the horizontal support frames 45 and 55 could instead be raised or lowered by the motor 18.

Print heads that can be used other than inkjet heads include thermal heads and wire-dot heads and the like.

This invention can also be applied to ordinary printers that do not use media trays but transport rollers to transport the recording media. In such a case, the transport rollers could be arranged to be movable towards or away from the print head.

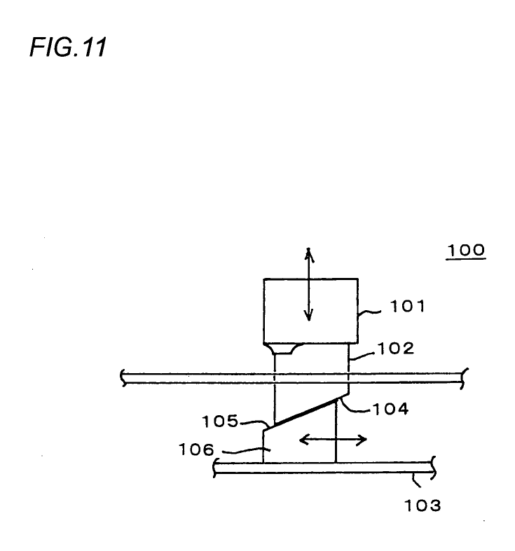

Conversely to the above example, it is also possible to adopt an arrangement for adjusting the gap between the print head and the recording media that is being transported by raising or lowering the print head. For example, as shown in FIG. 11, by using a base 102, a print head 101 of a printer 100 could be attached to the printer body 103 in a way that allows the print head to be moved in a vertical direction. A sloping surface 104 is formed on the base 102 and a trapezoidal member 106 having a sloping surface 105 in close contact with the sloping surface 104 is affixed to the printer body 103 in a horizontally movable state. When a motor (not shown) is used to move the trapezoidal member 106 horizontally, the print head 101 is moved up or down by the sliding contact of the two sloping surfaces 104 and 105, thereby increasing or decreasing the gap between the print head 101 and the recording media. With such a configuration in which the print head is moved, the same effect could be obtained as in the case of the foregoing example.

Also, in the above example water-based ink is used to print on the surface of the artificial nail material. However, printing can be carried out using oil-based ink (solvent ink) instead of water-based ink. In such a case, it would be possible to omit the step of forming an image-receiving surface on the artificial nail material.

### INDUSTRIAL APPLICABILITY

As described in the foregoing, in the printing system of this invention, printing media such as artificial nail material or the like is carried by the inkjet printer media transport tray with the media loaded on the media support sheet. The media transport tray is moved through a position at which the loaded printing media is printed by the inkjet head. Thus, it is possible to readily manufacture artificial nails printed with preferred designs and pictures.

Moreover, in accordance with the invention, a water-based ink image receiving layer is formed on the surface of the printing media, making it possible to use print on various types of media using an inkjet printer.

1. A printing system using an inkjet printer, comprising:
a container that houses printing media,
an inkjet printer for printing on the printing media, and
a drive controller that controls the driving of the inkjet printer, wherein
the container includes a media support sheet on which the printing media is removably loaded, and a container main body in which the media support sheet is removably housed,
the inkjet printer includes an inkjet head, a media transport tray that can be moved through a position at which printing is carried out by the inkjet head, and a gap adjustment mechanism that adjusts a gap between the inkjet head and the media transport tray, and
the media transport tray is capable of carrying the media support sheet in a positioned state, and wherein
the media transport tray carrying the media support sheet is conveyed through the printing position to carry out printing on a surface of the printing media carried on the media support sheet.

2. A printing system according to claim 1, wherein
the drive controller has a printing data supply section that supplies the inkjet printer with printing data,
the printing data supply section includes a printing data acquisition section that acquires printing data externally, and a printing data storage section that stores the acquired printing data, and the printing data acquisition section includes at least one selected from among a printing data receiving section that receives printing data via a communications network, a printing data reading section that reads in printing data stored on storage media, and an image reading section that acquires image data from a scanner that reads printed materials or from a digital camera or video disc or the like.

3. A printing system according to claim 2, wherein the printing data supply section of the drive controller has a printing data selection section that selects printing data to be supplied to the inkjet printer, and the printing data selection section has a keyboard and/or a touch-panel comprising a printing data selection signal input section.

4. A delivery data printing system, wherein it includes a printing data delivery center that delivers printing data, and a plurality of printeries equipped with the printing system as set forth in claim 3 that is able to receive printing data that is delivered.

5. An artificial nail printing system using an inkjet printer, comprising:
a container that houses artificial nail material before it is printed with designs or the like,
an inkjet printer for printing on the artificial nail material, and
a drive controller that controls the driving of the inkjet printer, wherein
the container includes an artificial nail support sheet on which the artificial nail material is removably loaded, and a container main body in which the artificial nail support sheet is removably housed,
the inkjet printer includes an inkjet head, a media transport tray that can be moved through a position at which printing is carried out by the inkjet head, and a gap adjustment mechanism that adjusts a gap between the inkjet head and the media transport tray, and
the media transport tray is capable of carrying the artificial nail support sheet in a positioned state, and wherein
the media transport tray carrying the media support sheet is conveyed through the printing position to carry out prescribed printing on a surface of the artificial nail material carried on the media support sheet.

6. An artificial nail printing system according to claim 5, wherein
the drive controller has a printing data supply section that supplies the inkjet printer with printing data,
the printing data supply section includes a printing data acquisition section that acquires printing data externally, and a printing data storage section that stores the acquired printing data, and
the printing data acquisition section includes at least one selected from among a printing data receiving section that receives printing data via a communications network, a printing data reading section that reads in printing data stored on storage media, and an image reading section that acquires image data from a scanner that reads printed materials or from a digital camera or video disc or the like.

7. An artificial nail printing system according to claim 6, wherein the printing data supply section of the drive controller has a printing data selection section that selects printing data to be supplied to the inkjet printer, and
the printing data selection section has a keyboard and/or a touch-panel comprising a printing data selection signal input section.

8. An artificial nail printing system according to claim 5, wherein a water-based ink image receiving layer is formed on the printing surface of the artificial nail material, and the inkjet printer is used to print on the image receiving layer in water-based ink.

9. An artificial nail printing system according to claim 8, wherein it further comprises a drier for drying the printed image formed on the image receiving surface of the artificial nail material.

10. The container that houses artificial nail material used in the artificial nail printing system according to claim 5.

11. A delivery data printing system, wherein it includes a printing data delivery center that delivers printing data, and a plurality of printeries equipped with the artificial nail printing system as set forth in claim 7, that is able to receive printing data that is delivered.
